(19) United States
(12) Patent Application Publication
(10) Pub. No.: US 2025/0001424 A1
(43) Pub. Date: Jan. 2, 2025

(54) CENTERING HOLDER FOR CENTERING ONE SAMPLE TUBE

(71) Applicant: Roche Diagnostics Operations, Inc., Indianapolis, IN (US)

(72) Inventor: Daniel Mueller, Rotkreuz ZG (CH)

(21) Appl. No.: 18/692,099

(22) PCT Filed: Sep. 13, 2022
(86) PCT No.: PCT/EP2022/075397

§ 371 Date: Mar. 14, 2024

(30) Foreign Application Priority Data
Sep. 14, 2021 (EP) 21196537.1

(51) Int. Cl. B01L 9/06

(52) U.S. Cl. CPC B01L 9/06; B01L 2200/023; B01L 2300/123

(57) ABSTRACT

A centering holder for centering and holding one sample tube the centering holder being adaptable to sample tubes having different diameters is disclosed. The centering holder comprises: at least two coupled centering fingers arranged and configured to adapt to the diameter of the sample tube and for applying a centering force onto the sample tube in a direction towards a center axis of the centering holder, wherein each of the centering fingers comprises at least one rod element and at least one sleeve, wherein the sleeve at least partially surrounds the rod element, wherein the sleeve is configured for physically contacting the sample tube thereby transferring the centering force onto the sample tube; and at least one base element configured for supporting the at least two rod elements of the centering fingers.

### TECHNICAL FIELD

The invention relates to a centering holder for centering and holding one sample tube, to a sample handling system for handling a sample comprising said centering holder, to a centering method for centering a sample tube and to a handling method for handling a sample. The devices and methods of the present invention, as an example, may be used in the field of medical or chemical laboratories in which typically at least one sample has to be handled. The sample may contain a liquid sample, for example a biological sample, such as blood, blood plasma, blood serum, urine, saliva, stool or other types of bodily fluid, and/or a chemical sample, such as a reagent, a reactant or a solvent. As an example, the sample handling system may be used for processing the sample, such as for performing an analytical and/or a pre-analytical step with the sample to be handled. However, other types of applications comprising the handling of a sample are also feasible.

### BACKGROUND ART

In the field of medical or chemical laboratories, generally, a plurality of samples, for example liquid samples, have to be handled automatically. In these laboratories, each sample is usually contained in a sample tube, wherein for different samples differently shaped sample tubes may be used, the sample tube is typically placed in a tube holder and may be transported through the laboratory from one location to another, for example from a pre-analytical module to an analytical module or the like. The handling of sample tubes is usually performed automatically, for example when transferring samples in between transport modules and/or analyzing the sample in the pre-analytical module or in the analytical module, wherein accurate positioning of the sample tubes in the tube holders are crucial for avoiding errors during automatic handling.

As an example for a system holding a tube in a desired orientation, US20020040618 A1 describes a self-centering system for holding an object (e.g. a vial, tube or cell) to maintain the longitudinal axis of the object in the desired orientation. The system includes two cam members which are pivotably mounted on parallel axes. The cam members include sloped surfaces which are able to accommodate objects of various diameters or shapes (e.g. circular or non-circular cross-section). The cam members are biased (e.g. with weights or springs) such that the sloped surfaces are automatically brought into contact with the object to be oriented and supported.

U.S. Pat. No. 9,180,460 B2 describes an apparatus having a) a flat, flexible test tube holder ring, and b) a mechanism to manipulate the angular orientation of the flat flexible test tube holder ring. The test tube holder ring includes: an outer circumference, an inner circumference, and apertures to hold test tubes, wherein alternate apertures have circumferential walls to enable positioning the test tubes higher compared to their adjacent test tubes. The mechanism includes an engagement mechanism that orients the angle of the test tube holder ring. When the test tube holder ring is at one angle, the test tube holder ring is flat and planar, and when the test tube holder is at a different angle the test tube holder ring has a conical shape.

EP 600130 A2 describes an article holding arrangement including an article holder which defines an article holding portion, is formed of an urethane type foamed body and having a higher density at an outer skin portion than that of a core portion. The article holder also includes an article fixing device for holding an article set in an article holding portion of an article holder with an article holding member, which comprises a first magnet, to which the article holding member is fixed, movably supported on the article holder for movement in an article holding direction, a second magnet supported on the article holder in opposition to the first magnet, and the first and second magnets being provided the same magnetic poles at mutually opposing poles. The article holding arrangement further includes a damping device for preventing articles transported through a transportation line in series, which comprises a damping magnets arranged at the mutually mating portions of the articles adjacent along the transportation line, which damping magnets of adjacent articles are provided the same polarities at the mutually opposing magnetic poles.

CN 207576474 U describes a compact and flexible test tube rack, including a number of placement plates, which are arranged horizontally side by side, and the material of the placement plates is flexible soft material; each placement plate is provided with a number of upper and lower through the placement holes; a number of pairs of fixing members, each pair of fixing members includes two, respectively, fixed to the two ends of each placement plate; adjacent to the two placement plates on the same side of the fixing members are hinged by hinges; between each pair of fixing members The bottom plate is located underneath the placement plate, and the material is an elastic soft material. The compact and flexible test tube holder described in the utility model, through the soft and flexible material of the placement plate, can make the interfering test tubes around the target test tube to move away automatically when the test tube is taken, and automatically collect when the taking is completed. The structure makes the placement holes on the placement plate more densely arranged and does not interfere with the access to the test tubes. Compared with the test tube rack in the prior art, the utility model is more compact and takes up less space.

CN 108114763 A relates to the field of test equipment, and specifically describes a test tube holder. The test tube fixing frame includes vertically arranged vertical plates, and between the plates there are fixed plates for test tubes to be inserted for fixing and support plates for supporting the bottom of the test tubes in order from top to bottom, and said plates have more than two slots spaced along the vertical direction, and said slots have slot walls for supporting the support plates and/or fixed plates inserted in the slots to be connected between the plates, and said slots are arranged along the horizontal direction. The slots are arranged in the horizontal direction; at both ends of the slots are provided with a limit structure to limit the displacement of the support plate and/or the fixed plate in the direction of the slot arrangement. The limit structure can ensure that the support plate and/or the fixed plate will not move in the slot during the test, and achieve fixation. And the spacing between the support plate and the fixing plate can be changed by inserting the support plate and/or fixing plate in different slots, so as to adapt to different sizes of test tubes with higher applicability.

US 2010/015 007 A1 describes an integrated system for processing vessels containing samples. The integrated system generally has: a frame; a reagent dispensing station, a sample digestion station, a sample cooling station, a sample normalization station and a sample filtration station within the frame; a vessel manipulation unit having a vessel manipulating member displacing the vessels containing the samples between the reagent dispensing station, the sample digestion station, the sample cooling station, the sample normalization station and the sample filtration station; and a controller communicatively coupled to the vessel manipulation unit, the controller having a processor and a memory having stored thereon instructions which when executed by the processor displace the vessels containing the samples from one station to another.

EP 3 093 071 A1 describes a test tube carrier for transporting test tubes in a laboratory automation system comprising a base body and at least three centering fingers attached to the base body, wherein the centering fingers are distributed about a central axis, wherein each centering finger comprises an elongate, bent resilient element and a strut having a higher stiffness than the resilient element wherein the struts extend in parallel to the central axis, and wherein a first end of the associated resilient element is fixedly attached to the strut at an upper position and a second end of the resilient element contacts the strut at a lower position between the base body and the upper position. The invention further relates to a laboratory distribution system having a number of test tube carriers, and a laboratory automation system comprising a laboratory distribution system.

Despite the advantages achieved by the known methods and devices, several technical challenges remain in the field of laboratory systems. Specifically, known methods and devices for handling sample tubes are usually limited to handling one specifically shaped sample tube, e.g. to sample tubes having a specific diameter.

### Problem to be Solved

It is therefore desirable to provide devices and methods which at least partially address the above-mentioned technical challenges. Specifically, devices and methods shall be proposed which allow for a flexible and customized automated handling of sample tubes in a laboratory system.

### SUMMARY

This problem is addressed by a centering holder for centering and holding one or more sample tubes and by a sample handling system for handling a sample with the features of the independent claims. Further proposed are a centering method for centering a sample tube and a handling method for handling a sample. Advantageous embodiments which might be realized in an isolated fashion or in any arbitrary combinations are listed in the dependent claims as well as throughout the specification.

As used in the following, the terms “have”, “comprise” or “include” or any arbitrary grammatical variations thereof are used in a non-exclusive way. Thus, these terms may both refer to a situation in which, besides the feature introduced by these terms, no further features are present in the entity described in this context and to a situation in which one or more further features are present. As an example, the expressions “A has B”, “A comprises B” and “A includes B” may both refer to a situation in which, besides B, no other element is present in A (i.e. a situation in which A solely and exclusively consists of B) and to a situation in which, besides B, one or more further elements are present in entity A, such as element C, elements C and D or even further elements.

Further, it shall be noted that the terms “at least one”, “one or more” or similar expressions indicating that a feature or element may be present once or more than once typically will be used only once when introducing the respective feature or element. In the following, in most cases, when referring to the respective feature or element, the expressions “at least one” or “one or more” will not be repeated, non-withstanding the fact that the respective feature or element may be present once or more than once.

Further, as used in the following, the terms “preferably”, “more preferably”, “particularly”, “more particularly”, “specifically”, “more specifically” or similar terms are used in conjunction with optional features, without restricting alternative possibilities. Thus, features introduced by these terms are optional features and are not intended to restrict the scope of the claims in any way. The invention may, as the skilled person will recognize, be performed by using alternative features. Similarly, features introduced by “in an embodiment of the invention” or similar expressions are intended to be optional features, without any restriction regarding alternative embodiments of the invention, without any restrictions regarding the scope of the invention and without any restriction regarding the possibility of combining the features introduced in such way with other optional or non-optional features of the invention.

In a first aspect of the present invention, a centering holder for centering and holding one or more sample tubes, specifically during transport of the at least one sample tube in a sample handling system, is disclosed. The centering holder is adaptable, specifically at least within a predetermined adaption range, to sample tubes having different diameters.

The term “sample tube” as used herein is a broad term and is to be given its ordinary and customary meaning to a person of ordinary skill in the art and is not to be limited to a special or customized meaning. The term specifically may refer, without limitation, to an arbitrary cylindrically shaped container for a sample, specifically a liquid sample. Specifically, the sample tube may be used in the field of medical and/or chemical laboratories. In particular, the sample tube may be an arbitrary individual container for transporting, storing and/or processing a content, e.g. a sample, received by the sample tube. For example, the sample tube may be a cylindrical container, e.g. a cylindrical tube having a circular and/or polygon a cross-section. For example, the sample tube may be an ampoule. In particular, the sample tube may comprise a body, e.g. a cylindrically and/or tube-shaped body, for containing the sample and may comprise an open end, such as an opening, pointing upwards. As an example, the body may have a flat or rounded bottom. Further, as an example, the sample tube may also comprise a closure, such as a foil and/or cap for scaling the sample tube. In particular, the sample tube may be a piece of laboratory glass- or plastic-ware optionally comprising a cap on its upper end. For example, the sample tube may be a glass or a transparent plastic tube. The sample tube may specifically have a tube axis, such as an axis through a center of the sample tube. In particular, the tube axis may be an axis of symmetry, such as an axis through a geometrical center of the sample tube or through a center of gravity or mass of the sample tube. For example, the tube axis may be an axis through a geometrical center of area, surface, position or mass of the sample tube.

The term “sample handling system” as used herein is a broad term and is to be given its ordinary and customary meaning to a person of ordinary skill in the art and is not to be limited to a special or customized meaning. The term specifically may refer, without limitation, to an arbitrary system comprising at least one component configured for performing at least one function of handling at least one sample contained in at least one sample tube. The handling of samples may comprise at least one of: transporting samples in the sample handling system; analyzing samples; preparing samples for analysis, for example by splitting samples, mixing samples, adding one or more reagents, reactants or solvents to the samples. The handling may specifically be performed at least partially or even fully automatically. The sample, for example, may be a liquid sample contained by the sample tube. In particular, the sample handling system may comprise a plurality of components which may be configured for interacting together to perform the at least one function of handling samples. Further, each of the components of the sample handling system may be configured for performing at least one function of handling samples such as gripping a sample tube, pipetting sample from a sample tube, sealing off a foil onto an open sample tube, or the like. The sample handling system may be configured for performing a plurality of different functions of handling liquid samples. The sample handling system may specifically be configured for automatically handling samples, specifically for handling samples individually, such as one sample after another. In particular, the sample handling system may be a part of an automated laboratory, such as of an automated workflow series.

The term “sample” as used herein is a broad term and is to be given its ordinary and customary meaning to a person of ordinary skill in the art and is not to be limited to a special or customized meaning. The term specifically may refer, without limitation, to an aliquot of substance such as a chemical or biological compound. Specifically, the sample may be or may comprise at least one biological specimen, such as one or more of: blood; blood serum; blood plasma; urine; saliva, stool. Additionally or alternatively, the sample may be or may comprise a chemical substance or compound and/or a reagent. The sample may specifically be a liquid sample, such as an aliquot of a fluid substance of the chemical or biological compound. For example, the liquid sample may be or may comprise at least one pure liquid, such as a liquid substance and/or a solution containing one or more liquid substances, comprising the at least one chemical and/or the biological substance. As another example, the liquid sample may be or may comprise a liquid mixture, such as a suspension, and emulsion and/or a dispersion of one or more chemical and/or biological substances. However, other, in particular non-liquid samples, are also possible. Other sample types may be, for example, tissue or homogenized material.

The term “adaptable” as used herein is a broad term and is to be given its ordinary and customary meaning to a person of ordinary skill in the art and is not to be limited to a special or customized meaning. The term specifically may refer, without limitation, to a process of accommodating and/or adjusting to a given environment within certain adaption constraints and/or conditions. Thus, in particular, the centering holder being adaptable to sample tubes having different diameters, may specifically refer to the centering holder's ability to adapt to and/or accommodate sample tubes having different diameters at least within a predetermined adaption range. Specifically, the centering holder may be configured for adapting to sample tubes having different diameters within a predetermined adaption range, such as to diameters falling within a minimum adaptable diameter, e.g. a lower border, and a maximum adaptable diameter, e.g. an upper border. As an example, the centering holder may be adaptable to sample tubes having different diameters varying between 5 mm and 45 mm, specifically between 8 mm and 25 mm, more specifically between 10 mm and 18 mm, even more specifically between 11 mm and 17 mm. Additionally or alternatively, the centering holder may be adaptable to sample tubes having different diameters varying between 25 mm and 45 mm, between 17 mm and 25 mm and/or between 10 mm and 17 mm. Other ranges may be possible. Thus, the centering holder may for example be adaptable to sample tubes having diameters varying between ±20 mm, specifically±15 mm, specifically±6 mm.

The term “centering” as used herein is a broad term and is to be given its ordinary and customary meaning to a person of ordinary skill in the art and is not to be limited to a special or customized meaning. The term specifically may refer, without limitation, to a process of changing a sample tube's orientation and/or position within the centering holder, such as to align a tube axis, e.g. a center axis of the sample tube, with a center axis of the centering holder. In particular, the centering may refer to a process of aligning the sample tube's axis with the centering holder's center axis, such that the sample tube's axis is coaxial to the axis of the centering holder. As an example, the process of centering the sample tube may comprise transferring the sample tube into an upstanding and/or vertical orientation within the centering holder. In particular, the sample tube may be centered by the centering holder such that the sample tube is in a vertical position and such that an opening center, e.g. a center of an opening of the sample tube, may be concentric to a center of the centering holder. Specifically, the centering may lead to a coaxiality of the center axis of the sample tube with the center axis of the centering holder, e.g. a coaxial alignment of the sample tube's center axis with the center axis of the centering holder, within a predetermined tolerance. Thus, as an example, the sample tube may be considered to be centered by the centering holder in case, with regard to the center axis of the centering holder, the sample tube's axis is tilted by no more than 8°, specifically by no more than 4°, more specifically by no more than 2°, even more specifically by no more than 1°. Additionally or alternatively, the sample tube may be considered to be centered in case a distance between a center of the opening of the sample tube and the centering holder's center axis, i.e. a shortest distance and/or a distance at the height of 100 mm above the sample tube's bottom, is less than 14 mm, preferably less than 7 mm, more preferably less than 3.5 mm, most preferably less than 1.75 mm.

The term “centering holder” as used herein is a broad term and is to be given its ordinary and customary meaning to a person of ordinary skill in the art and is not to be limited to a special or customized meaning. The term specifically may refer, without limitation, to a holder configured for centering and holding one or more sample tubes, specifically when the at least one sample tube is inserted into the centering holder. In particular, the centering holder may be configured for centering and holding exactly one sample tube, wherein in this case, the centering holder may also be referred to as “centering single holder”. Additionally or alternatively, the centering holder may be configured for centering and holding more than one sample tube, i.e. a stack or a bundle of sample tubes.

The centering holder comprises:
at least two coupled centering fingers arranged and configured to adapt to the diameter of the sample tube and for applying a centering force onto the sample tube in a direction towards a center axis of the centering holder, wherein each of the centering fingers comprises at least one rod element and at least one sleeve, wherein the sleeve at least partially surrounds the rod element, wherein the sleeve is configured for physically contacting the sample tube thereby transferring the centering force onto the sample tube; and
at least one base element configured for supporting the at least two rod elements of the centering fingers.

The term “centering finger” as used herein is a broad term and is to be given its ordinary and customary meaning to a person of ordinary skill in the art and is not to be limited to a special or customized meaning. The term specifically may refer, without limitation, to an arbitrary elongated device, specifically having a fingerlike lengthy structure, configured for applying a centering force onto the sample tube. The centering finger may specifically be configured for applying the centering force onto the sample tube in a direction towards the center axis of the centering holder, wherein at least two centering fingers are used for centering the sample tube. The two centering fingers may preferably be arranged diametrically, such as on opposite sides of the center axis of the centering holder. Alternatively, more than two centering fingers may be used, specifically at least three centering fingers may be used, for centering the sample tube. As an example, the centering fingers may be arranged equally spaced, e.g. equidistantly, around the centering axis of the centering holder. Thus, in case only two centering fingers are present, an angle between the centering fingers may be approximately 180°, wherein in case three centering fingers are present, an angle between the centering fingers may be approximately 120° and in case four centering fingers are present, an angle between the centering fingers may be approximately 90°. Other arrangements may be possible. Further, the centering fingers may have a length adapted to a length of the sample tube. Thus, the centering finger may for example have a length that may be at least 10 mm shorter and/or smaller than a length of the at least one sample tube.

As outlined above, the at least two centering fingers of the centering holder are coupled. The term “coupled” as used herein is a broad term and is to be given its ordinary and customary meaning to a person of ordinary skill in the art and is not to be limited to a special or customized meaning. The term specifically may refer, without limitation, to a state of at least two arbitrary elements being connected, such that at least one movement of one of the two elements is transferred onto the other one of the two elements.

As further outlined above, each of the centering fingers comprises a rod element and a sleeve, wherein the sleeve at least partially surrounds the rod element. As used herein, the term “rod element” specifically may refer, without limitation, to an arbitrary rigid structure of the centering finger. As an example, the rod element may be or may comprise a stiff structural element of the centering finger, e.g. similar as a bone in an actual human or animal finger. The rod element is at least partially surrounded by the sleeve, wherein the term “sleeve” as used herein may specifically refer, without limitation, to an arbitrary structural element of the centering finger, configured to at least partially surround and/or enclose the rod element. As an example, the sleeve may be or may comprise a soft and/or flexible material, e.g. similar to flesh in an actual human or animal finger. Additionally or alternatively however, the sleeve may be or may comprise a rigid and/or stiff material, positioned such as to at least partially surround the rod element.

Further, the centering holder may specifically comprise at least one access slit, such as an access slit arranged between the at least two centering fingers. The term “access slit” as used herein is a broad term and is to be given its ordinary and customary meaning to a person of ordinary skill in the art and is not to be limited to a special or customized meaning. The term specifically may refer, without limitation, to an arbitrary opening, specifically arranged between the at least two centering fingers of the centering holder. In particular, the access slit may refer to a lengthy opening, such as to a strip- and/or slit-like window and/or void, specifically extending parallel to the centering fingers. As an example, the access slit may be arranged such as to allow an undisturbed view of at least part of the sample tube, when the sample tube is centered in the centering holder. In particular, the access slit may allow e.g. for reading a barcode label and/or for performing a sample quality check, such as a centrifugation status or the like.

The term “base element” as used herein is a broad term and is to begin its ordinary and customary meaning to a person of ordinary skill in the art and is not to be limited to a special or customized meaning. The term specifically may refer, without limitation, to an arbitrary carrying and/or support structure of the centering holder. Thus, the base element may specifically be arranged at a bottom and/or lower end of the centering holder and may specifically comprise at least one rigid and/or stiff material.

As an example, at least one of the sleeves may specifically comprise at least one centering surface configured for guiding the sample tube into a centered state when the sample tube is inserted into the centering holder. The term “centering surface” as used herein is a broad term and is to be given its ordinary and customary to a person of ordinary skill in the art and is not to be limited to a special or customized meaning. The term specifically may refer, without limitation, to a part of a skin and/or sheath element of the sleeve configured for guiding the sample tube into the centered state by physical contact. The centering surface may also refer to a centering edge and/or point. Thus, in particular, the centering surface may not be limited to a surface or plane, but instead may also refer to a line or point of the sleeve configured for guiding the sample tube into the centered state by physically contacting the sample tube.

In particular, the centering surface may comprise one or more segments, such as one or more parts and/or areas. As an example, at least one of the segments may be selected from the group consisting of a beveled segment, such as a beveled guiding surface for guiding the sample tube into the centering holder, and a rounded segment, such as a rounded guiding surface for guiding the sample tube into the centering holder.

Further, at least one of the sleeves may at least partially comprise one of a curvature shaped cross section, a v-shaped cross section, a w-shaped cross section and a u-shaped cross section. Specifically, a cross-section of the sleeve may at least partially have a curvature, such as a curved- or rounded-, a V-, a W- or a U-shape.

As an example, at least one sleeve may comprise at least two centering surfaces formed by at least one open side of the cross-section, e.g. by an upper side of the v- or u-shaped cross-section or by a lower side of the w-shaped cross-section. In particular, a width of the two centering surfaces may be adapted to a mean and/or average diameter of the sample tube. Specifically, the width of the two centering surfaces may be at least half of the largest diameter of the sample tube. Thus, as an example, in case the diameter of the sample tubes varies between 10 mm and 17 mm, the width may be 8.5 mm. As a further example, in case the diameter of the sample tubes varies between 25 mm and 45 mm, the width may be at least 22.5 mm, i.e. ≥25 mm.

Additionally or alternatively, the sleeve may comprise more than two centering surfaces, such as an equal number of centering surfaces, for example pairs of centering surfaces, i.e. formed by a stack of the v- or u-shaped cross sections. Specifically, the sleeve may comprise at least four or six centering surfaces, particularly symmetrically arranged centering surfaces, i.e. pairs of symmetrically arranged surfaces. In particular, the cross-section of the stack of the v- or u-shaped cross-sections may have a crown-like shape, wherein the edges and/or spikes of the crown-shaped cross-section, from inside to outside, increase in height and/or raise. Thus, in particular, the crown-shaped cross-section of the sleeve may be symmetrical and may have an equal number of spikes, wherein the outermost spikes may be the highest and the innermost spikes may be the lowest. The centering surfaces of the sleeve may specifically be arranged such that sample tubes with different diameters may be centered. In particular, each of the pairs of centering surfaces may have a different width, such as a width adapted to different sample tube diameters.

In particular, the centering surface may comprise at least one low friction material, such as a surface material having a low friction coefficient. As an example, the centering surface may comprise a Teflon material as a surface material. Other materials having a low friction coefficient may be possible.

The centering holder may comprise at least one elastic member. Additionally or alternatively, each of the centering fingers may comprise at least one elastic member. The term “elastic member” as used herein is a broad term and is to be given its ordinary and customary meaning to a person of ordinary skill in the art and is not to be limited to a special or customized meaning. The term specifically may refer, without limitation, to an arbitrary reversibly deformable material.

As an example, the elastic member may be arranged in one of the following ways: such that the elastic member is at least partially combined with the sleeve, such that the elastic member is at least partially combined with the rod, such that the elastic member is at least partially arranged between the sleeve and the rod, such that the elastic member is at least partially combined with the base element, such that the elastic member is at least partially arranged between the sleeve and the base element, such that the elastic member is at least partially arranged between the rod and the base element.

In particular, the elastic member may be supported by both the rod element and the sleeve, e.g. by being at least partially arranged between said elements or by being at least partially combined with one or both of the rod element and the sleeve, and may specifically be configured for biasing at least one force exerted onto one or both of the rod element and the sleeve. As an example, in this arrangement, each of the centering fingers may comprise the at least one elastic member.

Additionally or alternatively, the elastic member may be supported by both the base element and the rod element or by both the base element and the sleeve, e.g. by being at least partially arranged between said elements, and may specifically be configured for biasing at least one force exerted onto one or more of the base element, the rod element and the sleeve. In particular, the elastic member may be arranged such as to exert a force onto at least one of the centering fingers, specifically onto at least one of the sleeve or the rod element of the centering fingers, e.g. by clamping the at least two centering fingers together, in a direction towards the center axis of the centering holder. The elastic member may be supported by the base element and one or both of the rod element and the sleeve, i.e. depending on whether the elastic member exerts the force onto the rod element and/or the sleeve of the centering finger. In this arrangement, one elastic member may be sufficient for exerting the force onto the centering fingers, e.g. for clamping two centering fingers together. As an example, the clastic member may be configured for exerting the force onto the centering finger in an approximately mid-height position, e.g. in a position located halfway along an extension of either the sleeve or the rod element.

In particular, the centering force may at least partially be exerted by the elastic member. Specifically, the elastic member may be configured to exert a force, such as a countering force, as a reaction to compression, e.g. exerted by the sample tube. As an example, the elastic member may exert the countering force when the sample tube is inserted into the centering holder. Thereby, as an example, the countering force exerted by the elastic member may at least partially be supported by the rod element.

Specifically, the elastic member may be selected from the group consisting of: a spring element, specifically a metallic spring element, a torsion spring, a beam spring, a cantilever spring, a u-shaped spring, a z-shaped spring or any other element formed such as to comprise elastic features; an inherent elastic material, e.g. a reversibly deformable bulk material, specifically a rubber element, a foam rubber element, a rubber band, a rubber block, an elastic sealing material, or the like.

In each centering finger the sleeve may be supported by the rod element, wherein specifically with respect to the rod element a degree of freedom of the sleeve may be≤1. As an example, the sleeve may be supported by the rod elements such that with respect to the rod element the sleeve may be able to perform only one movement, such as a rotational movement, or no movement. In particular, the sleeve may be supported by the rod element via one or more of a hinged support, i.e. a living and/or integral hinge, an adhesive bond, a snapped connection, a clipped connection and/or a clamped connection. Thus, as an example, in case the sleeve is supported by the rod element via the hinged support, the sleeve may be able to at least partially perform a rotational movement around the hinged support, wherein in case the sleeve is supported by the rod element via an adhesive bond, except for being deformed, the sleeve may not be able to perform any movement relative to the rod element.

As an example, in case the sleeve is supported by the rod element via the hinged support, the sleeve may be pressed to the sample tube in a parallel fashion. Thus, at least a part, e.g. one segment, of the centering surface of the sleeve may be arranged parallel to the centering axis when the centering force is exerted onto the sample tube.

Additionally or alternatively, the sleeve may be supported by the rod element via a snapped connection, a clipped connection and/or a clamped connection. Thus, as an example, the sleeve may be connected and/or coupled to the rod element by one or more of a snap fit, a clip fit and/or a clamped fit connection.

As an example, the coupling configured for supporting the sleeve by the rod element, such as one or more of the hinged support, i.e. the living and/or integral hinge, the snapped connection, the clipped connection and/or the clamped connection, may at least partially be manufactured by using one or more of a molding process, e.g. an injection molding process and/or an additive manufacturing process, e.g. a 3D printing process, and/or a subtractive manufacturing process, such as a common machining process. In particular, the coupling, specifically the hinged support, may be manufactured and created in an already hinged state, such as in an additive manufacturing process. Alternatively, the coupling may be formed by manufacturing at least two separate parts that in conjunction, such as after assembly, form the coupling. As an example, at least one of the parts of the coupling may be elastically deformable, e.g. by comprising at least one plastic material, such that the coupling may be formed by pushing the parts, e.g. the components, together.

As outlined above, the centering holder comprises at least two centering fingers. However, specifically, the centering holder may comprise at least three centering fingers. Preferably, the centering holder may comprise at least four centering fingers.

As an example, the centering holder may comprise an even number of centering fingers, such as pairs of centering fingers. In particular, the centering fingers of a pair of centering fingers may be arranged diametrically, e.g. on opposing sides, around the center axis of the centering holder.

Further, as an example, the pairs of centering fingers may differ in length, wherein specifically two centering fingers within the pair of centering fingers may have the same length. In particular, at least one access slit may be arranged between the at least two longer centering fingers, such as above the at least two shorter centering fingers. As an example, the shorter centering fingers may be configured for ending below the access slit of the centering holder. Thus, in particular, readable information of the sample tube, e.g. from a barcode attached onto the sample tube, may for example be readable through the access slit above the shorter centering finger.

In the shorter centering fingers, the sleeve may be coupled and/or supported directly by an elastic member. In particular, the shorter centering fingers may be free of a rod element. Thus, as an example, the sleeve of the shorter centering fingers may be connected and/or coupled to the elastic member, e.g. to a u-shaped spring, by one or more of a snap fit, a clip fit and/or a clamped fit connection. Other supportive connections may be possible, such as a hinged support and/or an adhesive bond. Furthermore, i.e. in case the sleeve is coupled and/or supported directly by the elastic member, the two shorter centering fingers of the pair of shorter centering fingers may be coupled to each other, i.e. via the u-shaped spring, without a hinge and/or joint. Instead, the two shorter centering fingers of the pair of shorter centering fingers may be fixedly coupled to each other.

In case the centering holder comprises four centering fingers, as an example, one pair of centering fingers, e.g. to diametrically arranged centering fingers, may be longer than the other pair of centering fingers. However, in case the centering holder comprises three centering fingers, all three centering fingers may preferably have the same length. In particular, all centering fingers may be configured to excerpt the centering force onto the sample tube by one or more of the arrangements described herein.

The centering fingers may specifically be coupled by a fixed connection, such as a stiff and/or rigid connection, of the rod elements with the base element. As an example, the rod elements and the base element may be intrinsically fixed together, such as possibly even made in one part. Thus, the centering fingers may for example be fixedly coupled with each other via the base element, specifically by the rod elements being rigidly connected to the base element.

Additionally or alternatively, the centering fingers may be coupled by at least one hinged coupling, such as an arbitrary joint allowing at least one rotational movement of their at least two rod elements. Specifically, the at least one hinged coupling may be configured such that the centering fingers may have a degree of freedom of ≥2 with respect to each other. Thus, as an example, the hinged coupling may be or may comprise one or more of a combined rolling and sliding joint, a curved joint, i.e. a cam joint, a cylinder face joint, i.e. a cylinder surface joint, a ball joint, i.e. a ball face joint. In particular, the at least one hinged coupling may be arranged in at least one connecting element connecting the at least two rod elements, wherein each of the rod elements may be supported by the base element via a pinned support, e.g. via a hinged support and/or via a swivel joint.

As an example, the at least one hinged coupling may at least partially be manufactured by using one or more of a molding process, e.g. an injection molding process and/or an additive manufacturing process, e.g. a 3D printing process, and/or a subtractive manufacturing process, such as a common machining process. In particular, the hinged coupling may be manufactured and created in an already hinged state, such as in an additive manufacturing process.

Alternatively, the hinged coupling may be formed by manufacturing at least two separate parts that in conjunction, such as after assembly, form the hinged coupling. As an example, at least one of the parts of the hinged coupling may be elastically deformable, e.g. by comprising at least one plastic material, such that the hinged coupling may be formed by pushing the parts, e.g. the components, together.

As an example, the pinned support, i.e. for supporting the rod elements by the base element, may be manufactured in a similar fashion. Thus, the rod elements may be supported by the base element via a pinned support that at least partially may be manufactured by using one or more of a molding process, e.g. an injection molding process, and/or an additive manufacturing process, e.g. a 3D printing process, and/or a subtractive manufacturing process, such as a common machining process. In particular, the pinned support may be manufactured and created in an already hinged and/or pinned state, such as in an additive manufacturing process. Alternatively, the pinned support may be formed by manufacturing at least two separate parts that in conjunction, such as after assembly, form the coupling and/or support. As an example, at least one of the parts of the pinned support may be elastically deformable, e.g. by comprising at least one plastic material, such that the pinned support may be formed by pushing the parts, e.g. the components, together. Thus, the rod element may for example be manufactured, e.g. in an injection molding process, such that the rod element may have a circular recess and an opening slot, e.g. at a pivot point, and may then be plugged onto an axle of the base element, thereby forming the pinned support.

As an example, the at least one hinged coupling of the at least two rod elements may be configured such that the centering force may be distributed evenly onto the sample tube between the at least two centering fingers. Specifically, the rod elements and the at least one connecting element with the hinge may specifically be arranged such as to evenly distribute the centering force between the at least two centering fingers evenly, i.e. by a symmetric arrangement. In particular, each of the rod elements may function as a lever rotating around the pinned support in the base element, being driven by a movement of the hinged coupling.

Specifically, the rod elements and the at least one connecting element with the hinged coupling may be arranged such that a force acting on at least one of the rod elements, for example a force exerted by at least one spring element, e.g. by a clamp, may be distributed evenly between the centering fingers, specifically between the rod elements of the centering fingers.

Additionally or alternatively, the rod elements and the at least one connecting element with the hinge may be arranged such that a force acting on the hinged coupling may be transferred onto the rod elements and distributed evenly between the centering fingers. In particular, a downward movement of the hinged coupling, i.e. by a downward movement of the at least one connecting element, the rod elements may be forced to rotate around the pinned support in the base element, thereby transferring the downward movement of the hinged coupling into a pinching movement of the centering fingers, such as into a movement of the centering fingers in the direction of the center axis of the centering holder. Thus, specifically, a force exerted onto the hinged coupling of the at least two rod elements, i.e. onto the connecting element, specifically in a direction parallel to the center axis of the centering holder, may be transferred via the rod elements, i.e. functioning as levers, onto the sample tube inserted into the centering holder.

In particular, the centering force may at least partially be exerted by a force exerting element, such as a force exerting element configured for applying and/or exerting a force onto the coupled centering fingers, specifically onto at least one of the rod elements and/or onto the hinged coupling. Thus, by one or more of the arrangements as described above, the force exerted by the force exerting element may be transferred onto the sample tube, i.e. as centering force. Specifically, the force exerting element may be selected from the group consisting of: a magnetic element and a spring element. As used herein, the term “magnetic element” may specifically refer, without limitation, to an arbitrary component which is configured to generate a magnetic field. The magnetic element may preferably be a permanent magnet. The magnetic element may alternatively be an electromagnet.

Specifically, in case the force exerting element is selected to be a magnetic element, at least one of the two rod elements and/or the hinged coupling of the at least two rod elements may preferably be or may comprise at least one magnetizable material such as a material which is configured to, under the influence of a magnetic field, intensify the magnetic field and/or form a magnetic field by itself. Thus, as an example, under the influence of the magnetic element, the rod element and/or the hinged coupling may intensify the magnetic field and/or itself form a magnetic field, such that by magnetic force the rod element and/or the hinged coupling is drawn towards the magnetic element. By drawing the hinged coupling towards the magnetic element, the magnetic force may be transferred via the rod elements onto the sample tube in a direction towards the center axis of the centering holder. Additionally or alternatively, by drawing the rod element towards the magnetic element, the magnetic force may be transferred and distributed evenly via the hinged coupling onto the other rod element.

The hinged coupling of the at least two rod elements may specifically be arranged in the center axis of the centering holder below the sample tube, when the sample tube is positioned in the centering holder. In particular, in case the hinged coupling is arranged in the center axis of the centering holder, the connecting element may for example be beam shaped, such as to connect the rod elements straightly and/or in a direct fashion.

The hinged coupling of the at least two rod elements may alternatively be arranged around the sample tube, i.e. outside of the center axis of the centering holder, when the sample tube is positioned in the centering holder. Thus, in particular, in case the hinged coupling is arranged outside of the center axis of the centering holder, the connecting element may be formed in a round and/or oval fashion. As an example, the centering fingers may be coupled via at least two hinges and two connecting elements forming a round and/or oval, optionally intercepted by one or more straight and/or beam shaped sections and/or segments, connection between the rod elements. This may specifically have the advantage that the bottom of the sample tube may be positioned in a low position, i.e. is positioned lower than when the hinged coupling is arranged in the center axis of the centering holder. As an example, the low position of the sample tube may result in a lower center of gravity than when the hinged coupling is arranged in the center axis of the centering holder and may thus allow for a stable transport of the centering holder. Additionally or alternatively, the hinged coupling being arranged around the sample tube may further allow for a compact built of the centering holder, i.e. a lower maximum height of the centering holder with inserted sample tube, and may thus only require a small movement range for handling the centering holder. Thus, as an example, in case the hinged coupling is arranged around the sample tube, a lower movement range may be needed for a handling device, such as for a pipetting device or for a gripping device.

In a further aspect of the present invention, a sample handling system for handling a sample is disclosed. The sample handling system comprises at least one centering holder for centering and holding one sample tube, wherein the sample tube contains the sample. For definitions and embodiments, for example of the centering holder, reference is made to the definitions and embodiments as outlined in the context of the centering holder. Further, the sample handling system comprises at least one handling device. As an example, the at least one handling device may be or may comprise one or more of a gripping device, a transporting device, an analyzing device, a pipetting device, a sealing device. Other devices may be possible.

The sample handling system may further comprise at least one control unit for controlling at least one operation of the sample handling system. The term “control unit” as used herein is a broad term and is to be given its ordinary and customary meaning to a person of ordinary skill in the art and is not to be limited to a special or customized meaning. The term specifically may refer, without limitation, to a device, such a single device or a plurality of devices, comprising at least one computational element, such as at least one processor. As used herein, the term “processor” may refer to an arbitrary logic circuitry configured for performing basic operations of a computer or system, and/or, generally, to a device which is configured for performing calculations or logic operations. In particular, the processor may be configured for processing basic instructions that drive the computer or system. As an example, the processor may comprise at least one arithmetic logic unit (ALU), at least one floating-point unit (FPU), such as a math coprocessor or a numeric coprocessor, a plurality of registers, specifically registers configured for supplying oper-ands to the ALU and storing results of operations, and a memory, such as an L1 and L2 cache memory. In particular, the processor may be a multi-core processor. Specifically, the processor may be or may comprise a central processing unit (CPU). Specifically, the processor may be or may comprise at least one Graphics Processing Unit (GPU). Additionally or alternatively, the processor may be or may comprise a microprocessor, thus specifically the processor's elements may be contained in one single integrated circuitry (IC) chip. Additionally or alternatively, the processor may be or may comprise one or more application-specific integrated circuits (ASICs) and/or one or more field-programmable gate arrays (FPGAs) and/or one or more tensor processing unit (TPU) and/or one or more chip, such as a dedicated machine learning optimized chip, or the like. The control unit specifically may be configured, such as by software programming, for performing one or more control operations.

Further proposed is a centering method for centering a sample tube. The method comprises the following steps which may be performed in the given order. It shall be noted, however, that a different order is also possible. Further, it is also possible to perform one or more of the method steps once or repeatedly. Further, it is possible to perform two or more of the method steps simultaneously or in a timely overlapping fashion. The method may comprise further method steps that are not listed. For definitions and embodiments, for example of the centering holder, reference is made to the definitions and embodiments as outlined in the context of the centering holder.

The centering method comprises:
a) providing at least one centering holder according to the present invention, such as according to any one of the embodiments disclosed above and/or according to any one of the embodiments disclosed in further detail below;
b) centering the sample tube by inserting the sample tube into the centering holder.

Further proposed is a handling method for handling a sample. The method comprises the following steps which may be performed in the given order. It shall be noted, however, that a different order is also possible. Further, it is also possible to perform one or more of the method steps once or repeatedly. Further, it is possible to perform two or more of the method steps simultaneously or in a timely overlapping fashion. The method may comprise further method steps that are not listed. For definitions and embodiments, for example of the centering holder and/or the sample handling system, reference is made to the definitions and embodiments as outlined in the context of the centering holder and/or the sample handling system.

The handling method comprises:
i) providing at least one sample handling system according to the present invention, such as according to any one of the embodiments disclosed above and/or according to any one of the embodiments disclosed in further detail below;
ii) performing the centering method according to the present invention, such as according to any one of the embodiments disclosed above and/or according to any one of the embodiments disclosed in further detail below;
iii) handling the sample contained in the sample tube by handling, e.g. transporting, the centering holder.

Further, the handling method may comprise the following step:
iv) reading information, e.g. from a barcode attached onto the sample tube, of the sample and/or the sample tube through an access slit of the centering holder.

Specifically, the handling of the sample may be at least partially computer-controlled. For example, the handling of the sample may be at least partially controlled by the control unit of the sample handling system.

The devices and methods according to the present invention provide a large number of advantages of known methods and devices of similar kind. Specifically, the centering holder may allow to center sample tubes with different diameters and/or varying lengths accurately, for example, such that they stand vertical and that their tube axis is coaxial to the centering holder axis, i.e. such that no tilting of the sample tube and no displacement off a tube opening occurs with respect to the center axis of the centering holder, such as with respect to a centering holder's center. In particular, by allowing to center sample tubes with varying lengths, i.e. with different lengths, the devices and method according to the present invention may allow automatic and/or robotically supported gripping and/or placing of the sample tubes, i.e. sample tube pick and place by at least one robotic gripper.

In particular, the centering holder may allow for an active centering of the sample tubes even when the sample tubes are inserted into the centering holder slightly tilted, i.e. in a tilted position, such as for example in case a gripper for inserting the sample tube into the centering holder inserts the tube in a tilted fashion. Specifically, the centering holder may allow for a reliable, robust and repeatable centering of sample tubes, in particular of sample tubes having different tube diameters. Thus, it may specifically be a key function of the centering holder to make sure that the sample tube may be in a vertical position and that a center of the sample tube opening may be concentric with respect to a center of the centering holder.

Furthermore, the methods and devices according to the present invention may particularly allow for an organized automatic handling of samples. In particular, an organized automatic handling of samples may be ensured by allowing for a sample identification, preferably at any time, during sample handling. Thus, in particular, a barcode on the sample tube, i.e. on a tube wall, may be readable, preferably at any time, when the sample tube is centered in the centering holder. Specifically, an identification may be possible via the access slit of the centering holder. This may particularly be beneficial compared to a centering holder making use of a ring, i.e. of a ring-shaped spring or similar element, such as a ring surrounding the sample tube, specifically surrounding a tube wall.

In particular the methods and devices according to the present invention may increase operating efficiency and cost-effectiveness of sample handling, i.e. by reducing a waste and/or scrap rate. Specifically, by allowing for an effective centering of sample tubes, sample handling may be more effective and less prone to failure. As an example, a gripping of the sample tube during handling may be performed more smoothly if the sample tube is accurately centered. In particular, a possible crashing of the sample tube during gripping may effectively be avoided. Furthermore, it may be possible to smoothly and accurately perform a pipetting operation directly from a centered sample tube, specifically from the sample tube centered by the centering holder. Furthermore, and accurately centered sample tube may allow a sealing foil to be positioned correctly onto an open upper end of the sample tube, thereby effectively preventing the sample from evaporation and/or contamination.

As an example, an advantage of the methods and devices according to the present invention may specifically be an achievable high concentricity of inserted sample tubes, i.e. because of the coupling of the at least two centering fingers. Specifically the coupling of the at least two centering fingers may be beneficial in avoiding tilted sample tubes, i.e. resulting from friction between a tube surface and a surface of the centering fingers. Specifically, tilted sample tubes may be avoided. Thus, by coupling the centering fingers, i.e. via a hinge, a friction between the tube and the centering fingers may be reduced and/or even prevented. In particular, the present methods and devices may limit and/or even eliminate frictional effects that otherwise may prevent an effective centering of sample tubes, i.e. a centering by the centering fingers when the sample tubes are inserted into the centering holder in a slightly tilted orientation.

Summarizing and without excluding further possible embodiments, the following embodiments may be envisaged:

Embodiment 1: A centering holder for centering and holding one sample tube, e.g during transport of the sample tube in a sample handling system, the centering holder being adaptable, specifically at least within a predetermined adaption range, to sample tubes having different diameters, the centering holder comprising:
at least two coupled centering fingers arranged and configured to adapt to the diameter of the sample tube and for applying a centering force onto the sample tube in a direction towards a center axis of the centering holder, wherein each of the centering fingers comprises at least one rod element and at least one sleeve, wherein the sleeve at least partially surrounds the rod element, wherein the sleeve is configured for physically contacting the sample tube thereby transferring the centering force onto the sample tube; and
at least one base element configured for supporting the at least two rod elements of the centering fingers.

Embodiment 2: The centering holder according to the preceding embodiment, wherein the centering holder comprises at least one access slit arranged between the at least two centering fingers.

Embodiment 3: The centering holder according to any one of the preceding embodiments, wherein at least one of the sleeves comprises at least one centering surface configured for guiding the sample tube into a centered state when the sample tube is inserted into the centering holder.

Embodiment 4: The centering holder according to the preceding embodiments, wherein the centering surface comprises one or more segments.

Embodiment 5: The centering holder according to the preceding embodiment, wherein at least one of the segments is selected from the group consisting of a beveled segment, such as a beveled guiding surface for guiding the sample tube into the centering holder, and a rounded segment, such as a rounded guiding surface for guiding the sample tube into the centering holder.

Embodiment 6: The centering holder according to any one of the preceding embodiments, wherein at least one of the sleeves at least partially comprises one of a curvature shaped cross section, a v-shaped cross section, a w-shaped cross section and a u-shaped cross section.

Embodiment 7: The centering holder according to the preceding embodiment, wherein the at least one sleeve comprises at least two centering surfaces formed by an open side of the cross section.

Embodiment 8: The centering holder according to any one of the five preceding embodiments, wherein the centering surface comprises at least one low friction material, such as a surface material having a low friction coefficient, e.g. a Teflon material.

Embodiment 9: The centering holder according to any one of the preceding embodiments, wherein the centering holder comprises at least one elastic member.

Embodiment 10: The centering holder according to the preceding embodiment, wherein the elastic member is arranged in one of the following ways: such that the elastic member is at least partially combined with the sleeve, such that the elastic member is at least partially combined with the rod element, such that the elastic member is at least partially arranged between the sleeve and the rod element, such that the elastic member is at least partially combined with the base element, such that the clastic member is at least partially arranged between the sleeve and the base element, such that the elastic member is at least partially arranged between the rod element and the base element.

Embodiment 11: The centering holder according to any one of the two preceding embodiment, wherein the centering force is at least partially exerted by the elastic member.

Embodiment 12: The centering holder according to any one of the three preceding embodiments, wherein the elastic member is selected from the group consisting of: a spring element, specifically a metallic spring element, a torsion spring, a beam spring, a cantilever spring, a u-shaped spring, a z-shaped spring or any other element formed such as to comprise elastic features; an inherent elastic material, e.g. a reversibly deformable bulk material, specifically a rubber element, a foam rubber element, a rubber band, a rubber block, an elastic sealing material, or the like.

Embodiment 13: The centering holder according to any one of the preceding embodiments, wherein in each centering finger the sleeve is supported by the rod element, wherein with respect to the rod element a degree of freedom of the sleeve is ≤1.

Embodiment 14 The centering holder according to the preceding embodiment, wherein the sleeve is supported by the rod element via one or more of a hinged support, an adhesive bond, a snapped connection, a clipped connection and/or a clamped connection.

Embodiment 14: The centering holder according to any one of the preceding embodiments, wherein the centering holder comprises at least three, preferably at least four, centering fingers.

Embodiment 15: The centering holder according to any one of the preceding embodiments, wherein the centering holder comprises an even number of centering fingers, such as pairs of centering fingers, wherein the centering fingers of a pair of centering fingers are arranged diametrically around the center axis of the centering holder.

Embodiment 16: The centering holder according to the preceding embodiment, wherein the pairs of centering fingers differ in length, wherein the two centering fingers within the pair have the same length.

Embodiment 17: The centering holder according to the preceding embodiment, wherein at least one access slit is arranged between the at least two longer centering fingers, such as above the at least two shorter centering fingers.

Embodiment 18: The centering holder according to any one of the preceding embodiments, wherein the centering fingers are coupled by a fixed connection of the rod elements with the base element.

Embodiment 19: The centering holder according to any one of embodiments 1 to 16, wherein the centering fingers are coupled by at least one hinged coupling of their at least two rod elements, wherein the at least one hinged coupling is arranged in at least one connecting element connecting the at least two rod elements, and wherein each of the rod elements is supported by the base element via a pinned support, e.g. via a hinged support and/or a swivel joint.

Embodiment 20: The centering holder according to the preceding embodiment, wherein the hinged coupling of the at least two rod elements are configured such that the centering force is distributed evenly onto the sample tube between the at least two centering fingers.

Embodiment 21: The centering holder according to the preceding embodiment, wherein the centering force is at least partially exerted by a force exerting element selected from the group consisting of: a magnetic element and a spring element.

Embodiment 22: The centering holder according to any one of the three preceding embodiments, wherein the hinged coupling of the at least two rod elements is arranged in the center axis of the centering holder below the sample tube, when the sample tube is positioned in the centering holder.

Embodiment 23: The centering holder according to any one of the four preceding embodiments, wherein the hinged coupling of the at least two rod elements is arranged around the sample tube, when the sample tube is positioned in the centering holder.

Embodiment 24: A sample handling system for handling a sample, the sample handling system comprising at least one centering holder according to any one of the preceding embodiments for centering and holding one sample tube, the sample tube containing the sample, wherein the sample handling system further comprises at least one handling device.

Embodiment 25: The sample handling system according to the preceding embodiment, wherein the sample handling system comprises at least one control unit.

Embodiment 26: A centering method for centering a sample tube, the centering method comprising the following steps:
a) providing at least one centering holder according to any one of the preceding embodiments referring to a centering holder;
b) centering the sample tube by inserting the sample tube into the centering holder.

Embodiment 27: A handling method for handling a sample, the handling method comprising the following steps:
i) providing at least one sample handling system according to any one of the preceding embodiments referring to a sample handling system;
ii) performing the centering method according to the preceding embodiment;
iii) handling the sample contained in the sample tube by handling, e.g. transporting, the centering holder.

Embodiment 28: The handling method according to the preceding embodiment, wherein the handling method further comprises the following step:
iv) reading information, such as readable information of the sample tube, e.g. from a barcode attached onto the sample tube, of the sample and/or the sample tube through an access slit of the centering holder.

### SHORT DESCRIPTION OF THE FIGURES

Further optional features and embodiments will be disclosed in more detail in the subsequent description of embodiments, preferably in conjunction with the dependent claims. Therein, the respective optional features may be realized in an isolated fashion as well as in any arbitrary feasible combination, as the skilled person will realize. The scope of the invention is not restricted by the preferred embodiments. The embodiments are schematically depicted in the Figures. Therein, identical reference numbers in these Figures refer to identical or functionally comparable elements.

In the Figures:

FIG. 1 shows an embodiment of a sample handling system comprising an embodiment of a centering holder and a side view;

FIGS. 2a and 2b show an embodiment of a centering holder with a sample tube in a section view (2a) and in a top plane view (2b);

FIGS. 3a and 3b show the embodiment of the centering holder as illustrated in FIGS. 2a and 2b with a sample tube having a smaller diameter in a section view (3a) and in a top plane view (3b);

FIGS. 4a and 4b show an embodiment of a centering holder with a sample tube in a section view (4a) and in a top plane view (4b);

FIGS. 5a and 5b show the embodiment of the centering holder as illustrated in FIGS. 4a and 4b with a sample tube having a smaller diameter in a section view (5a) and in a top plane view (5b);

FIGS. 6a and 6b show an embodiment of a centering holder with a sample tube and including an exemplary depiction of a spring element in a section view (6a) and in a top plane view (6b);

FIGS. 7a and 7b show an embodiment of a centering holder with a sample tube and including an exemplary depiction of a spring element and a magnetic element in a section view (7a) and in a top plane view (7b);

FIGS. 8a and 8b show an embodiment of a centering holder with a sample tube in a section view (8a) and in a top plane view (8b);

FIGS. 9a and 9b show an embodiment of a centering holder with a sample tube and including an exemplary depiction of an additional pair of centering fingers in a section view (9a) and in a top plane view (9b);

FIG. 10 shows a flowchart of an embodiment of a centering method;

FIGS. 11 and 12 show flowcharts of different embodiments of a handling method; and

FIG. 13 shows an embodiment of a sleeve in a cross-sectional view.

### DETAILED DESCRIPTION OF THE EMBODIMENTS

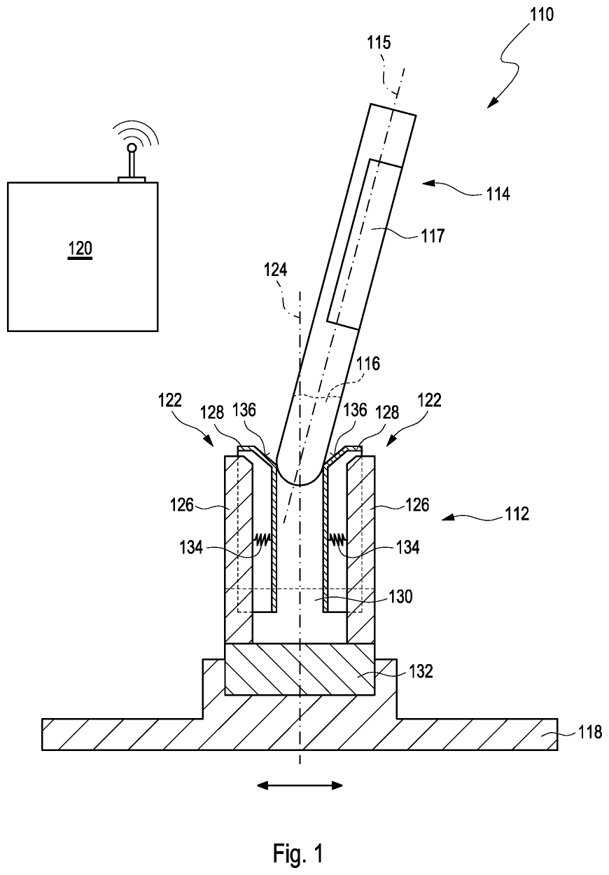

FIG. 1 shows an exemplary embodiment of a sample handling system 110 comprising at least one centering holder 112 for centering and holding one sample tube 114 having a tube axis 115, the sample tube containing a sample 116. The sample tube 114 may further comprise at least one readable information 117, such as a barcode and/or label. The sample handling system 110 further comprises at least one handling device 118. As an example, the handling device 118 may be or may comprise a transporting device configured for transporting the sample in one or more directions, two exemplary directions being indicated by the arrows illustrated in FIG. 1. Further, the sample handling system may comprise at least one control unit 120 for controlling at least one operation of the sample handling system 110.

The centering holder 112 for centering and holding the sample tube 114 is adaptable, specifically at least within a predetermined adaption range, to sample tubes 114 having different diameters. The centering holder 112 comprises at least two coupled centering fingers 122 arranged and configured to adapt to the diameter of the sample tube 114 and for applying a centering force onto the sample tube 114 in a direction towards a center axis 124 of the centering holder 112. Each of the centering fingers 122 comprises at least one rod element 126 and at least one sleeve 128. The sleeve 128 at least partially surrounds the rod element 126. Further, the sleeve 128 is configured for physically contacting the sample tube 114 thereby transferring the centering force onto the sample tube 114. Further, the centering holder 112 may comprise at least one access slit 130 arranged between the at least two centering fingers 122. Furthermore, the centering holder 112 comprises at least one base element 132 configured for supporting the at least two rod elements 126 of the centering fingers 122. As an example, the centering holder 112, specifically each of the centering fingers 122, may comprise at least one elastic member 134. The elastic member 134 may specifically be configured for at least partially exerting the centering force.

At least one of the sleeves 128 may comprise at least one centering surface 136, e.g. comprising one or more segments, configured for guiding the sample tube 114 into a centered state and the sample to 114 is inserted into the centering holder 112. Specifically, at least one of the sleeves 128 may at least partially comprise a curvature shaped cross-section, such as a cross-section being of a curved and/or rounded shape.

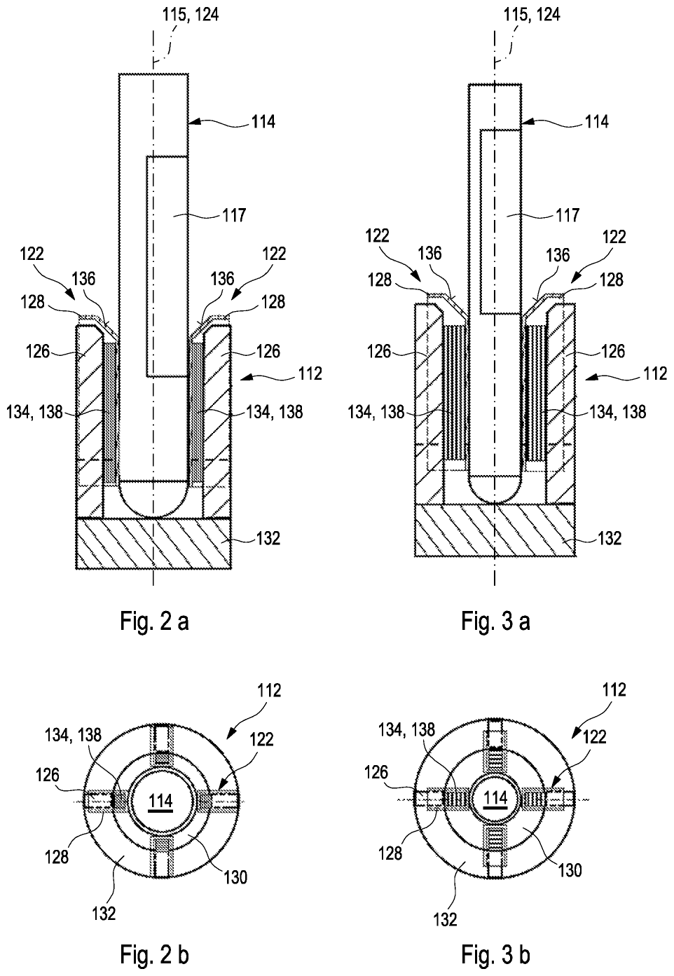

In FIGS. 2a, 2b, 3a and 3b a different exemplary embodiment of a centering holder 112 for centering and holding one sample tube 114 is illustrated in a section view (2a and 3a) and in a top plane view (2b and 3b), wherein in FIGS. 3a and 3b a sample tube 114 having a smaller diameter is centered than the sample tube 114 illustrated in FIGS. 2a and 2b. As an example, at least one of the sleeves 128 may comprise a u-shaped cross-section, wherein a bottom side of the u-shape of the sleeve 128 may be arranged towards, i.e. facing, the sample tube 114. Specifically, the sleeve 128 may be pressed towards the sample tube 114 by the elastic member 134 being formed by a reversibly deformable bulk material, such as a foam rubber element 138. As an example, the foam rubber element 138 may be adhesively bonded with both, the sleeve 128 and the rod element 126.

The centering holder 112 may specifically comprise four centering fingers 122, i.e. two pairs of centering fingers 122. The centering fingers 122 may be coupled by a fixed connection, such as by a rigid connection, of the rod elements 126 with the base element 132.

The at least one access slit 130 may be arranged between at least two of the centering fingers 122. Optionally, and as illustrated in FIGS. 2a to 3b, the centering holder 112 may comprise a plurality of access slits 130, their number correlating to a number of centering fingers 122, arranged between two centering fingers 122.

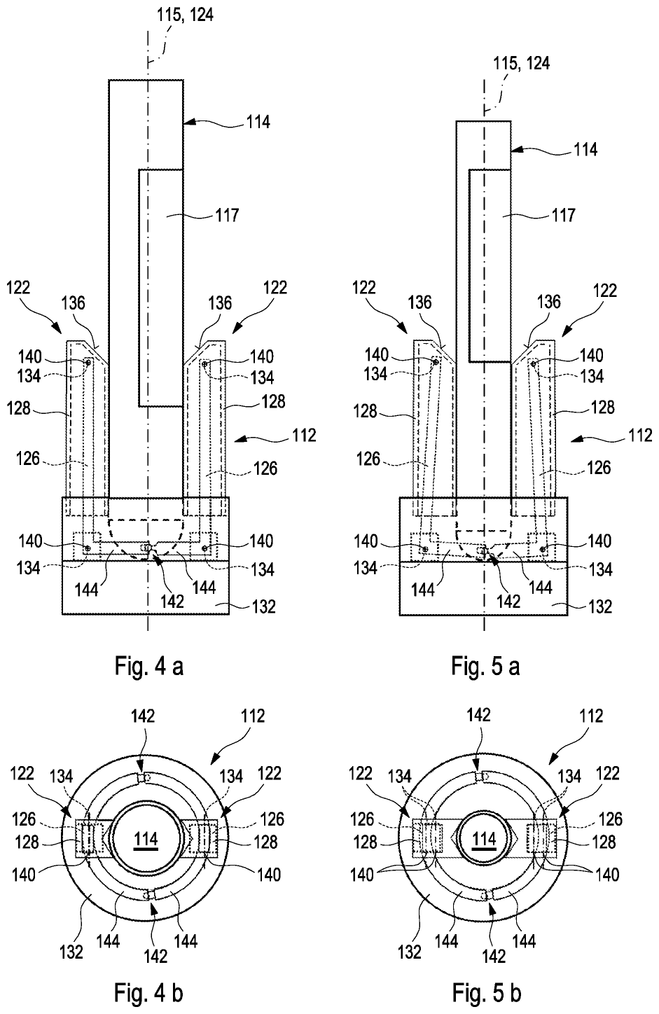

In FIGS. 4a, 4b, 5a and 5b a different exemplary embodiment of a centering holder 112 for centering and holding one sample tube 114 is illustrated in a section view (4a and 5a) and in a top plane view (4b and 5b), wherein in FIGS. 5a and 5b a sample tube 114 having a smaller diameter is centered than the sample tube 114 illustrated in FIGS. 4a and 4b. As an example, at least one of the sleeves 128 may comprise a w-shaped cross-section, wherein a bottom side of the w-shape of the sleeve 128 may be arranged towards, i.e. facing, the sample tube 114. In at least one of the centering fingers 122, preferably in both centering fingers 122, the sleeve 128 may be supported by the rod element 126 via a hinged support, such as via a hinge 140. As an example, each of the rod elements 126 may be supported by the base element 132 via a pinned support, e.g. via a further hinge 140. As an example, the centering force may at least partially be exerted by an elastic member 134, e.g. by a spring, which may be arranged in one or more of the hinges 140.

The centering fingers 122 may be coupled by at least one hinged coupling, e.g. a ball joint 142, of their at least two rod elements 126. Each hinged coupling may be arranged in at least one connecting element 144 connecting the at least two rod elements 126. Preferably, and as illustrated in FIGS. 4a to 5b, the centering fingers 122 may be coupled by two hinged couplings i.e. by two ball joints 142, each of which may be arranged in at least one connecting element 144. As an example, the connecting elements 144 may form a circle around the center axis 124 of the centering holder 112.

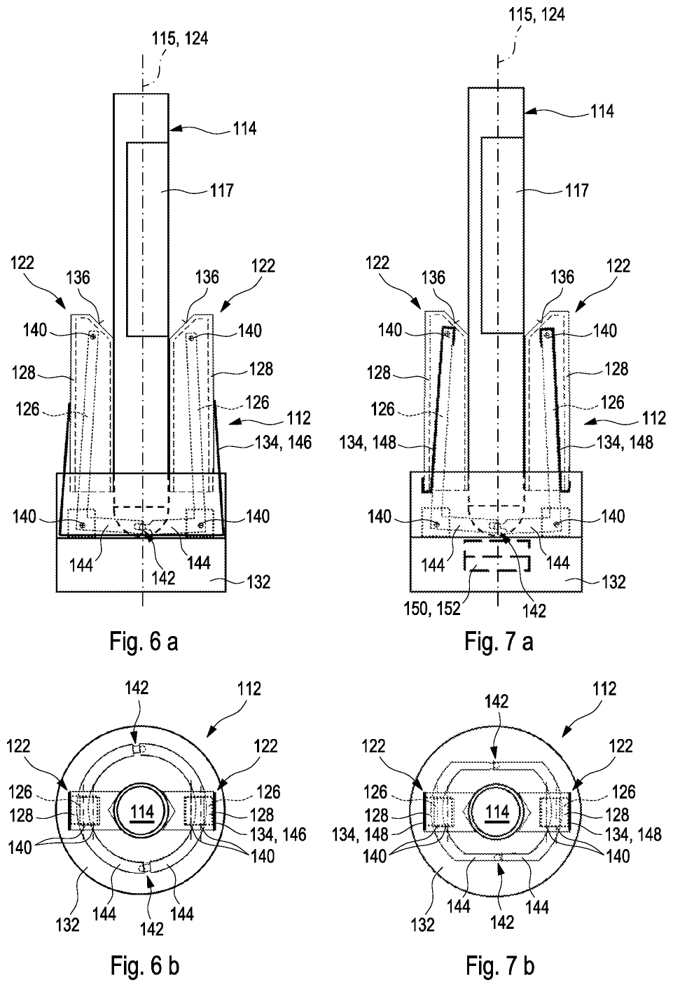

In FIGS. 6a to 9b different exemplary embodiments of centering holders 112 for centering and holding one sample tube 114 are illustrated, each in a section view (FIGS. 6a, 7a, 8a and 9a) and in a top plane view (FIGS. 6b, 7b, 8b and 9b).

The centering force may at least partially be exerted by an elastic member 134 formed as a u-shaped spring element 146, such as a clamp, e.g. as exemplarily illustrated in FIGS. 6a and 6b. In particular, the u-shaped spring element 146 may be arranged such that a spring force is exerted onto an outer side of at least one of the centering fingers 122, for example onto the sleeve 126, thus pushing the centering fingers 122 towards the center axis 124 of the centering holder 112, thereby exerting the centering force onto the sample tube 114.

Additionally or alternatively, the centering force may at least partially be exerted by an clastic member 134 formed as a z-shaped spring element 148, e.g. as exemplarily illustrated in FIGS. 7a and 7b. In particular, the z-shaped spring element 148 may be arranged between the sleeve 128 and the rod element 126 such that the sleeve 128 is pressed in a direction towards the center axis 124 and thus, onto the sample tube 114.

Additionally or alternatively, the centering force may at least partially be exerted by a force exerting element 150, wherein the force exerting element may specifically be a magnetic element 152, e.g. as exemplarily illustrated in FIGS. 7a and 7b. As an example, the hinged coupling of the at least two rod elements 126, i.e. the ball joint 142, and/or the connecting element 144 in which the at least one ball joined 142 may specifically be or may comprise at least one magnetizable material, such that by magnetic force the rod element 126 and/or the hinged coupling, specifically the ball joint 142 and/or the connecting element 144, may be drawn towards the magnetic element 152. As an example, by drawing the ball joints 142 and/or the connecting elements 144 towards the magnetic element 152, i.e. in a direction along the center axis 124 of the centering holder 112, the magnetic force may be transferred via the rod elements 126, e.g. acting as a lever, onto the sample tube 114 in a direction towards the center axis 124 of the centering holder 112.

As an example, the connecting elements 144 may form a round and/or oval connection between the rod elements 126, wherein the round and/or oval connection may specifically be intercepted by a straight segment.

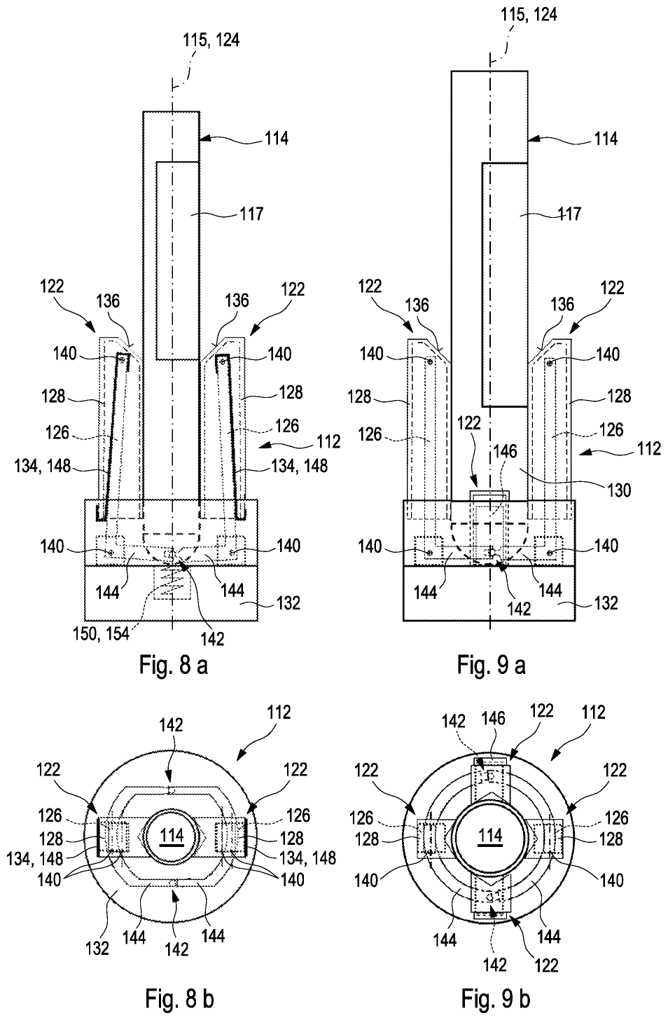

Additionally or alternatively, the centering force may at least partially be exerted by a force exerting element 150 formed by a spring element 154, e.g. as exemplarily illustrated in FIGS. 8a and 8b. As an example, the hinged coupling of the at least two rod elements 126, i.e. the ball joint 142, and/or the connecting element 144 in which the at least one ball joint 142 may be connected to the at least one spring element 154. The spring element 154 may be arranged such that the ball joints 142 and/or the connecting elements 144 are drawn downwards in a direction along the center axis 124 of the centering holder 112. Thereby, a spring force may be transferred by the rod elements 126, e.g. acting as a lever, onto the sample tube 114 in a direction towards the center axis 124 of the centering holder 112.

Centering holder 112 may comprise four centering fingers 122, specifically two pairs of centering fingers 122, wherein one pair of centering fingers 122 may be shorter in length than the other pair of centering fingers 122 e.g. as exemplarily illustrated in FIGS. 9a and 9b. As an example, the pairs of centering fingers may be arranged diametrically around the center axis 124 of the centering holder 112. The shorter centering fingers 122, specifically the pair of shorter centering fingers 122, may be configured for ending below the axis slit 130, i.e. such that the readable information 117 of the sample tube 114 may still be readable through the access slit 130.

In particular, all the centering fingers 122, i.e. both, the pair of the shorter centering fingers 122 and the pair of longer centering fingers 122, maybe configured to exert a centering force onto the sample tube 114 by one or more of the described arrangements. As an example, and as illustrated in FIGS. 9a and 9b, the centering force applied by the pair of shorter centering fingers 122 may at least partially be exerted by an elastic member 134 formed as a u-shaped spring element 146, such as a clamp. The centering force applied by the pair of longer centering fingers 122 may, for example, at least partially be exerted by an elastic member 134 at least partially arranged in one or more of the hinges 140 by which the rod elements 126 of the longer centering fingers 122 may be supported by the base element 132.

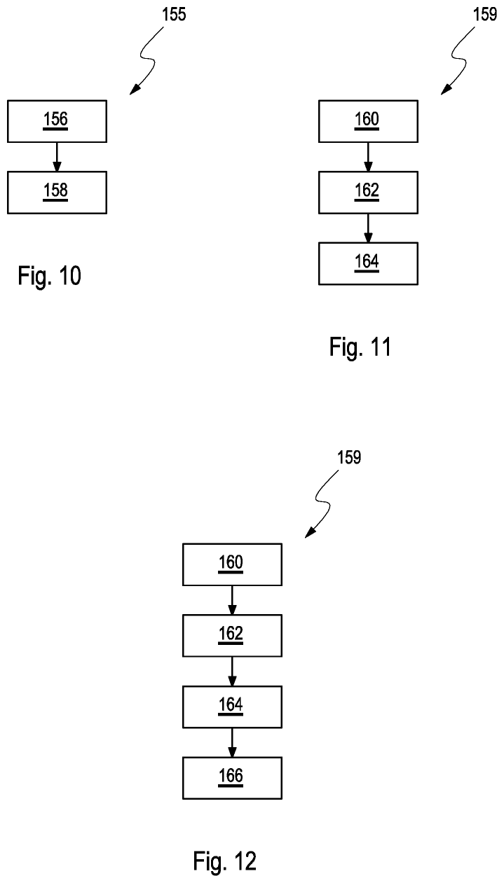

In FIG. 10, a flowchart of an embodiment of a centering method 155 for centering a sample tube 114 is shown. The centering method 155 comprises:
a) (denoted by reference number 156) providing at least one centering holder 112 according to any one of the embodiments disclosed above and/or according to any one of the embodiments disclosed in further detail below;
b) (denoted by reference number 158) centering the sample tube 114 by inserting the sample tube 114 into the centering holder 112.

In FIGS. 11 and 12, flowcharts of different embodiments of a handling method 159 for handling a sample 116 are shown. The handling method 159 comprises:
i) (denoted by reference number 160) providing at least one sample handling system 110 according to any one of the embodiments disclosed above and/or according to any one of the embodiments disclosed in further detail below;
ii) (denoted by reference number 162) performing the centering method 155 according to any one of the embodiments disclosed above and/or according to any one of the embodiments disclosed in further detail below;
iii) (denoted by reference number 164) handling the sample 116 contained in the sample tube 114 by handling, e.g. transporting, the centering holder 112.

As an example, the handling method 159 may further comprise the following step:
iv) (denoted by reference number 166) reading information, such as readable information 117 of the sample tube 114, e.g. from a barcode attached onto the sample tube 114, of the sample 116 and/or the sample tube 114 through an access slit 130 of the centering holder 112.

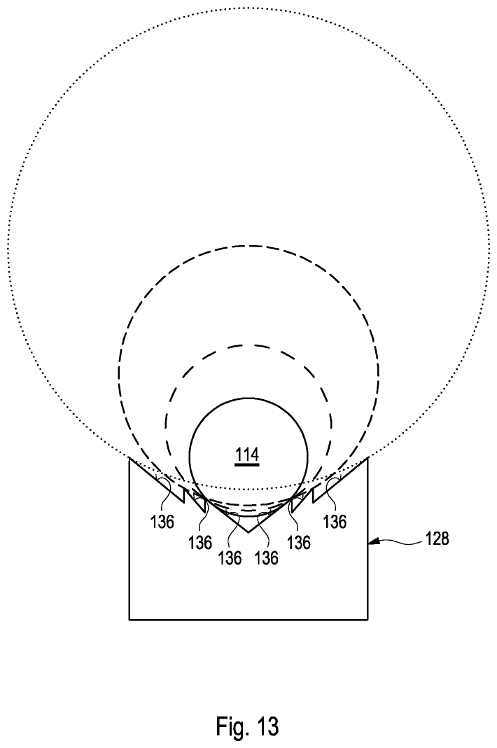

In FIG. 13, a cross-sectional view of an embodiment of a sleeve 128 is illustrated. Specifically, the illustrated sleeve 128 may have a crown-shaped cross-section with six symmetrically arranged centering surfaces 136. In particular, the centering surfaces may be arranged such that sample tubes 114 with different diameters may be centered. Exemplarily, in the Figure, sample tubes having four different diameters are illustrated in dashed or dotted lines. The centering surfaces 136 of the sleeve 128 may be arranged such that the crown-shaped cross-section of the sleeve 128 may be symmetrical and may have an equal number of spikes, wherein from inside to outside the spikes may increase in height and/or raise, i.e. the outermost spike may be the highest and the innermost spikes may be the lowest. Other cross-sections of the sleeve 128 may be possible, i.e. curvature, u- or v-shaped cross-sections.

### LIST OF REFERENCE NUMBERS

110 sample handling system
112 centering holder
114 sample tube
115 tube axis
116 sample
117 readable information
118 handling device
120 control unit
122 centering finger
124 center axis
126 rod element
128 sleeve
130 access slit
132 base element
134 elastic member
136 centering surface
138 foam rubber element
140 hinge
142 ball joint
144 connecting element
146 u-shaped spring element
148 z-shaped spring element
150 force exerting element
152 magnetic element
154 spring element
155 centering method
156 step a) of the centering method
158 step b) of the centering method
159 handling method
160 step i) of the handling method
162 step ii) of the handling method
164 step iii) of the handling method
166 step iv) of the handling method

1. A centering holder for centering and holding one or more sample tubes, the centering holder being adaptable to sample tubes having different diameters, the centering holder comprising:
at least two coupled centering fingers arranged and configured to adapt to the diameter of the sample tube and for applying a centering force onto the sample tube in a direction towards a center axis of the centering single holder, wherein each of the centering fingers comprises at least one rod element and at least one sleeve, wherein the sleeve at least partially surrounds the rod element, wherein the sleeve is configured for physically contacting the sample tube thereby transferring the centering force onto the sample tube; and
at least one base element configured for supporting the at least two rod elements of the centering fingers
wherein one or more of the following is realized
the centering holder comprises at least one elastic member, wherein the centering force is at least partially exerted by the elastic member;
the centering fingers are coupled by at least one hinged coupling of their at least two rod elements, wherein the at least one hinged coupling is arranged in at least one connecting element connecting the at least two rod elements, and wherein each of the rod elements is supported by the base element via a pinned support.

2. The centering holder according to claim 1, wherein the centering holder comprises at least one access slit arranged between the at least two centering fingers.

3. The centering holder according to claim 1, wherein at least one of the sleeves comprises at least one centering surface configured for guiding the sample tube into a centered state when the sample tube is inserted into the centering holder, wherein the centering surface comprises one or more segments.

4. The centering holder according to claim 1, wherein at least one of the sleeves at least partially comprises one of a curvature shaped cross section, a v-shaped cross section, a w-shaped cross section and a u-shaped cross section.

5. The centering holder according to claim 4, wherein the at least one sleeve comprises two centering surfaces formed by an open side of the cross section.

6. (canceled)

7. The centering holder according claim 1, wherein the elastic member is arranged in one of the following ways: such that the elastic member is at least partially combined with the sleeve, such that the elastic member is at least partially combined with the rod element, such that the elastic member is at least partially arranged between the sleeve and the rod element, such that the elastic member is at least partially combined with the base element, such that the elastic member is at least partially arranged between the sleeve and the base element, such that the elastic member is at least partially arranged between the rod element and the base element.

8. The centering holder according to claim 1, wherein the elastic member is selected from the group consisting of: a spring element, such as a z-shaped spring element; an inherent elastic material, such as a foam rubber element.

9. The centering holder according to claim 1, wherein in each centering finger the sleeve is supported by the rod element, wherein with respect to the rod element a degree of freedom of the sleeve is ≤1, wherein the sleeve is supported by the rod element via one or more of a hinged support, an adhesive bond, a snapped connection, a clipped connection and/or a clamped connection.

10. The centering holder according to claim 1, wherein the centering holder comprises an even number of centering fingers, such as pairs of centering fingers, wherein the centering fingers of a pair of centering fingers are arranged diametrically around the center axis of the centering holder.

11. The centering holder according to claim 10, wherein the pairs of centering fingers differ in length, wherein the two centering fingers within the pair have the same length, wherein at least one access slit is arranged between the at least two longer centering fingers, such as above the at least two shorter centering fingers.

12. The centering holder according to claim 1, wherein the centering fingers are coupled by a fixed connection of the rod elements with the base element.

13. (canceled)

14. The centering holder according to claim 1, wherein the hinged coupling of the at least two rod elements are configured such that the centering force is distributed evenly onto the sample tube between the at least two centering fingers, wherein the centering force is at least partially exerted by a force exerting element selected from the group consisting of: a magnetic element and a spring element.

15. A sample handling system for handling a sample, the sample handling system comprising at least one centering holder according to claim 1, the sample tube containing the sample, wherein the sample handling system further comprises at least one handling device.

16. The centering holder according to claim 1, wherein the sleeve at least partially surrounds and encloses the rod element, such that a bottom side of a shape of a cross-section of the sleeve is arranged towards the sample tube.

17. The centering holder according to claim 1, wherein the hinged coupling of the at least two rod elements is arranged in the center axis of the centering holder below the sample tube, when the sample tube is positioned in the centering holder.

18. The centering holder according to claim 1, wherein the sleeve at least partially surrounds and encloses the rod element, such that a bottom side of a shape of a cross-section of the sleeve is arranged facing the sample tube.
